(19) United States
(12) Patent Application Publication
(10) Pub. No.: US 2003/0216980 A1
(43) Pub. Date: Nov. 20, 2003

(54) Lock-and-key consumer billing data protection for electronic marketing

(75) Inventor: Neil Barry Rothfarb, West Hartford, CT (US)

Correspondence Address: PATTON BOGGS, PO BOX 270930, LOUISVILLE, CO, 80027, US

(73) Assignee: World Class Marketing

(21) Appl. No.: 10/146,249

(22) Filed: May 15, 2002

(51) Int. Cl. G06F 17/60

(52) U.S. Cl. 705/34

(57) ABSTRACT

A “lock-and-key” consumer billing data protection capability is provided to electronic marketing systems which are based upon previously-acquired consumer lists. The lists contain partial billing information for each consumer, which is insufficient to access the consumer's account. Thus, when a marketer employs this capability to communicate with a consumer, via an electronic message to offer them a product or service, the marketer remains “locked” out from accessing the consumer's account. When the consumer wishes to authorize the purchase of an offered product or service, the consumer must “reach into their wallet” to provide the “key” to their account via a return communication. They “key” is the missing billing information not acquired from the list provider.

### FIELD OF THE INVENTION

The present invention relates generally to computer systems, and more particularly to computerized order entry systems that support and facilitate consumer electronic marketing operations.

### PROBLEM

The practice of companies offering to sell goods or services directly to consumers, without requiring the consumer to visit a traditional (“bricks and mortar”) store, is known as direct marketing. In today's business climate, direct marketing has become ubiquitous.

Historically, one of the primary problems with direct marketing was that direct marketers did not precisely target consumers who were likely to buy their products or services. Rather, direct marketers routinely employed “cold calls” in an attempt to reach a broad range of consumers. Recently, however, direct marketers have recognized that consumers and the companies providing the goods and services which they market and sell would all benefit from targeted direct marketing. Accordingly, direct marketers have begun to target their efforts to those consumers who most likely would be receptive to the specific products and/or services being offered. Specifically, a direct marketing company attempting to sell a product or service of one of its clients may acquire a list of consumers who recently purchased related products or services. For example, a direct marketing company attempting to sell memberships in a dial-in roadside assistance service program may acquire a recent consumer list from a third-party vendor of car telephones.

In a specific application, direct marketers have begun to acquire lists of consumers for targeted electronic messages that contain product and/or service solicitations. For example, marketers contact consumers on-line over the Internet via electronic mail, instant messaging and the like. They are also employed in other electronic marketing systems in which, for example, marketers contact consumers with messages on their mobile phones, personal data assistants (PDAs) and the like via various wireless communications protocols.

When a consumer agrees to purchase a product or service offered by a marketer, in order to access that consumer's account (i.e., bill that consumer), it is necessary to possess certain “billing information.” At a minimum, this billing information includes the entire number, typically sixteen digits, of the consumer's credit card. The same billing information is required regardless of whether the entity accessing the consumer's account is the marketer itself, the seller, or any other entity hired to perform the billing operations.

There are two general approaches presently employed to acquire this billing information necessary to access a consumer's account.

The first approach is to acquire all of a consumer's billing information from the list provider that provided the consumer list being used by the marketer. Under this approach, a consumer's billing information is often acquired from the list provider before the marketer transmits a message to that consumer. Variations on this approach include acquiring a consumer's billing information only after the marketer transmits a message to the consumer and verifies that the consumer wants to purchase the offered product or service with the same credit card used for the prior purchase (commonly referred to as a “matchback”). Under the variations of this approach, however, all of the consumer's billing information is ultimately acquired from the list provider—and it is this information acquired from the list provider that is used to access the consumer's account.

The advantage of this approach is that it eliminates the need for consumers to transmit their credit card number over a communication medium that is not secure. This also protects consumers from transmitting billing information sufficient to access their account to entities posing as legitimate marketers.

The disadvantage of this approach, however, is that consumers are not in control of their billing information. As long as a marketer professes to have interpreted some response from a consumer as authorizing a purchase, the consumer's account can be charged.

The second approach is to acquire all of a consumer's billing information directly from the consumer. If a consumer wants to accept an offer to purchase a product or service as contained in an electronic message, that consumer must then return an electronic message that contains their entire credit card number to the marketer.

The advantage of this approach is that consumers are in control of their billing information. Without a consumer's credit card number, the marketer cannot bill consumers in those situations where they erroneously believe there has been authorization.

The disadvantage of this approach, however, is that consumers must transmit all of their billing information over an insecure communication medium, such as the Internet or other public communication medium. Consequently, consumers may transmit billing information sufficient to access their account to entities who are not legitimate marketers. In addition, this approach produces billing mistakes due to errors in the transmission and communication of the consumers' billing information to the marketer. Finally, from the marketers' perspective, this approach is not desirable because consumers are disinclined to transmit their entire credit card number over the Internet.

In summary, in the electronic environment, the first approach—where all of a consumer's billing information is acquired from a list provider—the disadvantage is that consumers are not in control of their billing information resulting in unintended purchases. For example, because such systems typically rely on a “one-click” order confirmation, the person may not realize that such a common and seemingly innocuous act of clicking the mouse may authorize a purchase to be charged on their credit card. Additionally, the person who “clicks” may not be the actual holder of the credit card but rather, for example, a colleague or child simply trying to clear the person's screen for some other purpose. In the second approach—where all of a consumer's billing information needs to be acquired directly from the consumer—the disadvantages remain: billing mistakes due to errors in the transmission and communication of the consumers' billing information to the marketer, and reluctance on the part of consumers to transmit all of their billing information, for fear of fraud.

Therefore, given the above, what is needed is a lock-and-key consumer billing data protection capability for electronic marketing systems that combines some or all of the advantages of the above-described approaches, while eliminating or reducing some or all of their respective disadvantages.

### SOLUTION

The present lock-and-key consumer billing data protection system for electronic marketing provides consumer billing account security to electronic marketing systems that are based upon consumer lists which may be presently available to the marketer or acquired from a list provider.

The lock-and-key consumer billing data protection system for electronic marketing, in one embodiment, includes a marketing database that stores consumer records presently available to the marketer or acquired from third-parties from whom such consumers have previously purchased goods or services. Each stored record includes consumer identification information and partial billing information. Because there is only partial billing information (fewer than all of the alphanumeric characters needed to access a consumer's account) presently available to the marketer or acquired from the list provider, the marketer, seller and companies hired to perform billing operations are “locked” out of every consumer's account.

The marketer typically uses an automated process executing on the marketing server which transmits an outbound electronic communication (electronic mail message, instant message, wireless text/multi-media message or the like) to a consumer. The electronic communication would contain a sales message and would request that the consumer reply with the “key”—the missing billing information—if they desire to purchase the offered product(s) and/or service(s). Once the consumer proactively provides the key in a return communication, this signals their acceptance of the offer contained in the initial outbound electronic communication. Only after the consumer supplies the “key,” can the consumer be charged. Specifically, now that all the consumer's billing information has been acquired—partly from the list presently available to the marketer or from the list provider and partly from the consumer—can the consumer's account can be accessed by the marketer, seller or an entity hired to perform billing operations for such purchases. Alternatively, the consumer can directly contact the marketer to initiate an inbound electronic communication session, or the marketer can initiate a communication session with the consumer regarding another product or service once the initial electronic communication session is concluded.

One advantage of the lock-and-key consumer billing data protection system for electronic marketing is that consumers are in control of their billing information. Without receiving the missing billing information (the “key”) from the consumer, no entity can bill the consumer based on an erroneous premise that authorization for a particular transaction was received during marketing activities. Unlike the approach of acquiring all of a consumer's billing information from a list provider, the lock-and-key consumer billing data protection system for electronic marketing “locks” companies out of a consumer's account until the consumer takes the proactive step of supplying the missing billing information—the “key”—in a reply electronic communication to the marketer.

Another advantage of the lock-and-key consumer billing data protection system for electronic marketing is that it eliminates the need for consumers to supply their entire credit card number over the insecure communication medium of the Internet or other publicly-accessible communications network.

Yet another advantage of the lock-and-key consumer billing data protection system for electronic marketing is that it provides an additional level of security to marketing activities. That is, a consumer's identity is verified by the need to proactively supply the key in order to access their billing information, rather than the “one-click” accept mechanism employed during electronic marketing, which could result in unintended purchases.

Yet another advantage of the lock-and-key consumer billing data protection system for electronic marketing is that companies can more safely share consumer information. The exchange of partial billing information under this system offers more consumer protection and privacy than the current exchange of complete billing information. Specifically relevant in the context of electronic retailing, companies may share consumers' partial billing information while retaining consumers' unique log-in and password information for their respective Web sites.

Further features and advantages of the invention as well as the structure and operation of various embodiments of lock-and-key consumer billing data protection for electronic marketing are described in detail below with reference to the accompanying drawings.

### BRIEF DESCRIPTION OF THE FIGURES

The features and advantages of the present lock-and-key consumer billing data protection system for electronic marketing will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram illustrating the architecture of a lock-and-key consumer billing data protection system for electronic marketing and a typical environment in which it is operational;

FIG. 2 is a flow chart depicting the operation of a lock-and-key consumer billing data protection system for electronic marketing; and

FIG. 3 is a flow chart depicting the operation of a lock-and-key consumer billing data protection system for electronic marketing for some alternative marketing senarios.

### DETAILED DESCRIPTION

Overview

The present lock-and-key consumer billing data protection system for electronic marketing relates to providing a “lock-and-key” consumer billing data protection capability to electronic marketing systems. In an embodiment, a marketer offering to sell particular good(s) and/or service(s) acquires a list of consumers (typically from a list provider) or has in its possession a list of consumers. This list typically identifies consumers who have recently purchased other products and/or services.

Such consumer lists presently available to the marketer or transferred to the marketer from the list provider contain only partial billing information (p alphanumeric characters of the m+p alphanumeric character consumer billing information) for each consumer. That is, the partial billing information comprises a predetermined subset of data from the consumer's complete billing data, and fails to include the entirety of the billing data. One such example is a string of consecutive digits of the consumer's account number. Because complete billing information is needed to access a consumer's account, the present lock-and-key consumer billing data protection system for electronic marketing “locks” out the marketer, the seller, and even an entity hired to perform billing operations for such purchases from accessing the consumer's account.

When a consumer is contacted electronically by a marketer, and wants to make a purchase, the lock-and-key consumer billing data protection system for electronic marketing requires that the consumer takes a proactive step to unambiguously order the offered product(s) and/or service(s) by providing certain alphanumeric characters from their credit card—the “key”—in order to authorize the purchase. The marketer, seller or company hired to perform billing operations now has all of the consumer's billing information and, as a result, can access that consumers account.

Lock-and-key consumer billing data protection empowers consumers with the ability to buy products and services over the Internet or wireless mobile communications networks while controlling access to their account and eliminating the need to supply all of their billing information. Thus, the lock-and-key consumer billing data protection system for electronic marketing guards against consumers being billed for products or services whose purchase they neither authorized, nor intended to authorize by requiring consumers to take the affirmative, proactive step of communicating part of their billing information to a marketer in order to authorize a purchase. At the same time, the lock-and-key consumer billing data protection system for electronic marketing prevents anyone, other than the consumer, who may have access to the consumer's computer, PDA, mobile phone, and the like from accidentally authorizing a purchase with, for example, a simple mouse click on the consumer's behalf. Finally, this system guards against entities that are not legitimate marketers by denying them access to all of a consumer's billing information.

The present lock-and-key consumer billing data protection system for electronic marketing is described in terms of the above example. This is for convenience only and is not intended to limit the application of the present lock-and-key consumer billing data protection system for electronic marketing. In fact, after reading the following description, it will be apparent to one skilled in the relevant art(s) how to implement the lock-and-key consumer billing data protection system for electronic marketing in alternative embodiments (inbound marketing upsells, other types of commerce, etc.).

Glossary

Below are definitions of terms used herein. In the event that a term defined herein has a more common meaning or usage, the definition provided herein should be taken as the intended meaning.

“Billing information” means the minimum data needed in order to charge or otherwise gain access to a consumer's account, such as a credit card, checking, savings, share or similar account, utility bill, mortgage loan account or debit card. In most instances, such minimum information is a set of alphanumeric characters, such as the typical sixteen-digit credit card account number.

“Partial billing information” means some portion (less than all) of the billing information.

“Credit card” means any debit, prepaid, charge, or credit card (whether private label or bank issued), or plate, coupon book or other credit device existing for the purpose of obtaining money, property, labor, or services as authorized by the consumer in whose name the credit card is issued.

“Consumer” means any person who is or may be required to pay for goods, services or a charitable contribution offered or solicited through telemarketing.

“Consumer identification information” means the data used to contact a consumer (name, telephone number, street address, electronic mail address, etc.).

“List Provider” means an entity that provides the marketer with a list of consumers for use in their activities. The list typically identifies consumers who recently purchased other products or services and typically includes only partial billing information (p alphanumeric characters of the m+p alphanumeric character consumer billing information) for each consumer, as noted above.

“Seller” means any person who incurs the obligation to a consumer to provide, or to have others provide, goods or services to the consumer in exchange for consideration from the consumers account.

“Marketer” means any person who, in connection with marketing activities (plans, programs or campaigns which are conducted to induce the purchase of goods or services or charitable contributions) initiates or receives electronic communications (electronic mail, instant or text messages and the like) to or from a consumer. For simplicity of description, the term “marketer” is used herein to include the instances where the marketer is also the seller, since such a distinction is unnecessary for the purpose of describing the operation of the lock-and-key consumer billing data protection system for electronic marketing.

Lock-and-Key System

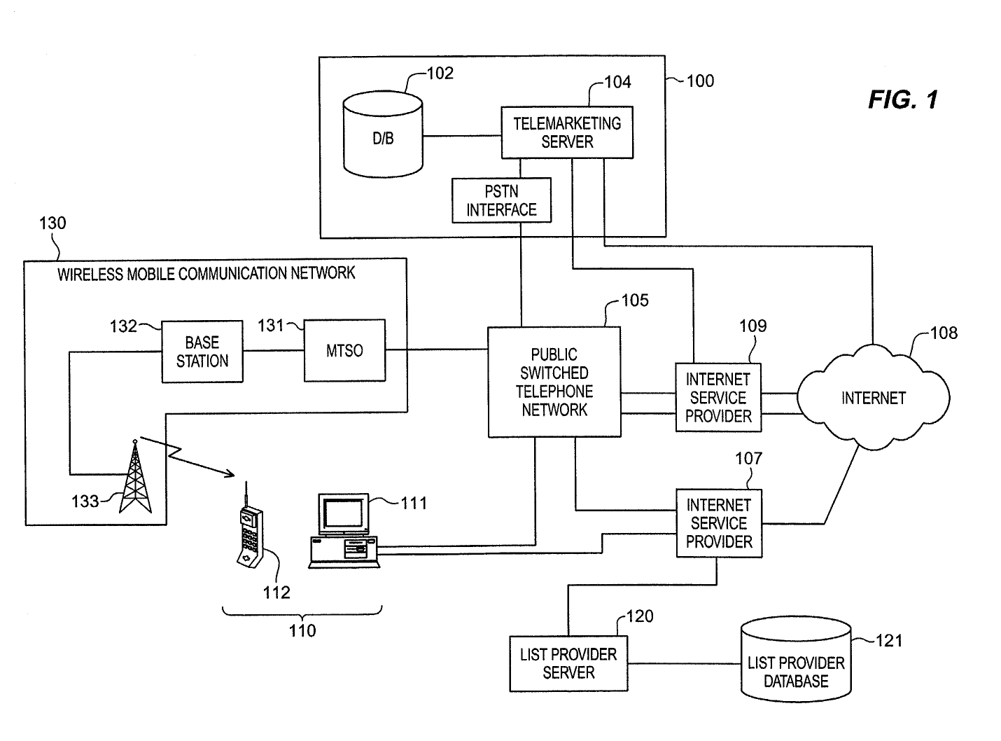

FIG. 1 is a block diagram that illustrates the architecture of a lock-and-key consumer billing data protection system for electronic marketing 100, termed “consumer billing data protection system” herein. FIG. 1 highlights the connectivity among the various components of consumer billing data protection system 100.

Consumer billing data protection system 100 includes a repository database 102. Database 102, in an embodiment, is a computer running database management server software with physical media which acts as a central store for information within consumer billing data protection system 100. That is, database 102 stores the consumer lists presently available to the marketer or received by the marketing entity, including the records containing consumers' identification information, the partial billing information, any key received from a consumer and possibly any collected demographic information.

In an alternate embodiment, database 102 would only store records containing consumers' contact and demographic information. That is, a seller engaging a marketer to perform marketing activities on its behalf would retain the partial billing information (except for the name of the credit card) for added consumer protection from possibly untrustworthy marketing entities.

Returning to FIG. 1, a marketing server 104 is the data processor of consumer billing data protection system 100, and is connected to database 102. Marketing server 104 retrieves certain data that is stored in database 102 and uses this data to originate electronic communications via electronic mail, instant messaging, text messages and the like to identified consumers in a well-known fashion.

The consumers are typically equipped with one or more of: a personal desktop computer 111, personal laptop computer, hand held computing device, mobile phone 112, personal digital assistant or other subscriber communication device, collectively termed “subscriber terminal equipment” 110 herein. Each consumer's subscriber terminal equipment 111 is generally served by a communications network which allows it to communicate with marketing server 104.

Returning to marketing server 104, it may be configured to communicate with one or more satellite and/or terrestrial wireless mobile communications networks 130. As shown in FIG. 1, the wireless mobile communications network 130 consists of a Mobile Telephone Switching Office (MTSO) 131 that serves one or more base stations 132, that transmit and receive wireless communications with mobile phone 112 via antenna 133. Access to wireless mobile communications network 130 is obtained through the Public Switched Telephone Network 105 and allows the marketing server 104 to communicate electronically with consumers using certain portable wireless subscriber terminal equipment 1 10 (mobile phones, personal data assistants and the like) in the form of text/multi-media messages via various wireless communications protocols.

Alternatively, the marketing server 104 can originate electronic messages for transmission to the consumer's personal computer 111 via the Internet 108. In this mode, the marketing server 104 generates an electronic message addressed to the consumer at their Internet e-mail address and transmits this message via a communications connection from marketing server 104 directly via the Internet 108 or to an Internet Service Provider 109 with whom the consumer billing data protection system 100 has an account. The Internet Service Provider 109 receives the electronic message and forwards the electronic message via the Internet 108 to the Internet Service Provider 107 with whom the consumer has an account. When the consumer connects to this Internet Service Provider 107 from their personal computer 111, the Internet Service Provider 107 delivers the electronic message to the consumer. The consumer can have access to the Internet 108 in many ways, such as via the Public Switched Telephone Network 105, cable modem, high speed data connection, satellite communications, and the like.

Marketing server 104 also allows consumer billing data protection system 100 to store consumer lists presently available to the marketer or to receive the consumer lists from a list provider. That is, a plurality of servers, such as list provider server 120 belonging to list providers may be authorized to access consumer billing data protection system 100 via the public, global Internet 108. (FIG. 1, however, shows only one list provider server 120 for ease of explanation herein.) Such list provider servers would then transfer consumer records to consumer billing data protection system 100 for storage onto database 102 under the control (authorization, scheduling, validation, etc.) of marketing server 104. In an alternate embodiment, list provider servers 120 would access consumer billing data protection system 100 via a dial-in line over the Public Switched Telephone Network (PSTN) 105, rather than the global Internet 108, to PSTN Interface 103.

While one databases 02 is shown in FIG. 1 for ease of explanation herein, consumer billing data protection system 100 may utilize one or more databases physically located on one or more computers, which may or may not be the same as marketing server 104. Further, in an alternate embodiment, database 102 may be mirrored for fault tolerance and marketing server 104 may be implemented as on one or more computers in a mirrored or distributed fashion as well.

Lock-and-Key Process

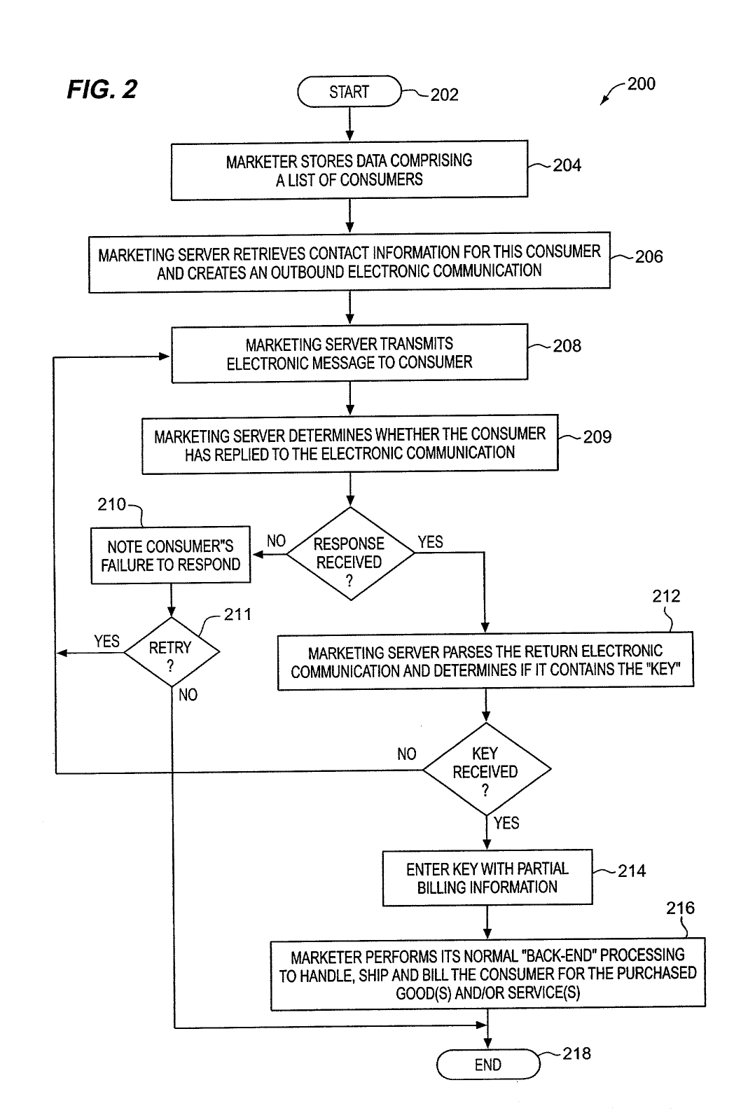

FIG. 2 is a flow chart depicting the operation of the lock-and-key consumer billing data protection system 100. Billing data protection process 200, which illustrates the order-entry functionality, consumer security and other advantages of consumer billing data protection system 100, begins at step 202, with control passing immediately to step 204.

In step 204, a marketer has presently available or receives, either directly or indirectly via a seller engaging the marketer, data comprising a list of consumers (in the form of database records) and their partial billing information, such as from a list provider, which data is stored in the database 102 associated with marketing server 104. In an embodiment, such consumers typically would have recently purchased good(s) and/or service(s) related to those presently being offered by the marketer. In an alternate embodiment, the list of consumers may be created or acquired “inhouse“by the marketer or seller (for example, by a research department or an affiliated entity). In either event, the received consumer list contains only partial billing information (typically, the name of the credit card and a portion of the credit card number) for each consumer. Marketing server 104 receives such consumer records from a list provider's server 120 over the Internet 108 or a dial-in line. In alternate embodiments, marketing server 104 receives and loads such consumer records from removable storage media. Marketing server 104 then stores the list in database 102 and may block access to a portion of the consumer account information by not allowing access to this partial billing information. The method of restricting access to a portion of a data record on a processor is well known and not described in detail herein.

In an alternate embodiment, the received consumer list does not contain any partial billing information, except for the name of the credit card and/or expiration date. That is, a seller engaging the marketer to perform marketing activities on its behalf may choose to retain the partial billing information. While this does not allow the marketer to perform certain functions (billing information verification), it allows the seller to provide for added consumer protection from possibly untrustworthy marketers.

In an alternate embodiment, the received consumer list contains the partial billing information in encrypted form. That is, a seller engaging the marketer to perform marketing activities on its behalf may choose to provide the partial billing information, with the partial billing information being inaccessible (encrypted) absent the provision of the key by the consumer. In another embodiment, only an entity hired by the seller to perform billing would receive the consumer list containing the partial billing information (either encrypted or unencrypted). The consumers' accounts would be inaccessible absent the provision of the key by the consumer.

Returning to process 200, in step 206, a particular consumer from the list received in step 204 is identified by marketing server 104 and the marketing server 104 retrieves the contact information for this consumer from database 102. The identification of consumers from the list may be done by marketing server 104 in several fashions, including: randomly, alphabetically, geographically or the like. In step 208, an automated system executing, for example, on marketing server 104 acreates an outbound electronic communication (electronic mail, instant message or the like) to a consumer using subscriber terminal equipment 111 which is also connected to the Internet 108. In an alternate embodiment, the outbound electronic communication is a text/multi-media message sent to a consumer using certain portable wireless subscriber terminal equipment 110 (mobile phone 112, personal data assistant and the like) via wireless mobile communications network 130. The electronic communication constitutes an offer that contains the sales message and would request that the consumer reply with the “key”—the missing billing information—if they desire to purchase the offered product(s) and/or service(s).

In step 209, consumer billing data protection system 100 (marketing server 104) determines, within a pre-determined time period, whether the consumer has replied to the electronic communication. If the determination of step 209 is negative, billing data protection process 200 notes the failure of consumer to reply in database 102 at step 210. At step 211 a determination is made by marketing server 104 whether to retry transmission of the electronic communication to the selected consumer. If not, processing terminates for this consumer at step 218. If a retry is elected, processing returns to step 208.

Otherwise, if the determination of step 210 is positive (a reply communication has been received from the consumer), billing data protection process 200 proceeds to step 212. The return communication from the selected consumer can be in any of a number of modes. The consumer can return an e-mail message to the marketing server 104, or can connect to the marketer's WEB site via the Internet 108, or the consumer can telephone the PSTN Interface 103 of the consumer billing data protection system 100 via a standard telephone (or cellular telephone) to provide the “key” to authorize the sale via tone signaling or an interaction with an agent, automated or not. In step 212, consumer billing data protection system 100 (marketing server 104) parses the return electronic communication and determines if it contains the “key”—the missing billing information which the seller needs in order to access the consumer's account and bill them for the purchased good(s) and/or service(s). In an embodiment of lock-and-key consumer billing data protection, the key is m alphanumeric characters of the m+p alphanumeric character billing information where consumer billing data protection system 100 has previously stored the p alphanumeric characters in step 204 in marketing server 104. In an alternate embodiment, the key is the missing m alphanumeric characters of the m+p alphanumeric character credit card billing information in addition to other data unique to the consumer or the consumer's account (such as the ACS code commonly located on credit cards), and this additional information need not be part of the billing information needed to access consumers' account.

If the determination of step 212 is negative, billing data protection process 200 then returns to step 208. Step 208 may then be repeated for the particular consumer to again request the key or referred to a consumer service sales agent for specialized processing and follow-up. Otherwise, if the determination of steps 209 and 212 are positive, this indicates that the consumer proactively provided the key by sending a return electronic communication (electronic mail, instant message, wireless text/multi-media message or the like). The return communication containing the key is the consumer's acceptance of the sales message's offer contained in the initial outbound electronic communication. Billing data protection process 200 then proceeds to step 214, where the key is entered into memory with the partial billing information to complete the consumer's billing information.

In step 216, the marketer and/or seller then performs its normal “back-end” processing to handle, ship—if applicable—and then bill the consumer for the purchased good(s) and/or service(s). Billing data protection process 200 then ends as indicated by step 218.

It should be understood that process 200, which highlights the functionality and other advantages of consumer billing data protection system 100, is presented for example purposes only. The present lock-and-key consumer billing data protection system for electronic marketing is sufficiently flexible and configurable such that process 200 may occur in ways other than that shown in FIG. 2. For example, in an alternate embodiment, the outbound electronic communication (step 208) may contain a hyperlink specifying a Uniform Resource Locator (URL) which, when clicked by the consumer in order to accept the accompanying sales offer, brings the consumer to a specific page on the marketer's Web site in order to enter the key (steps 210-212).

Alternative Marketing Scenarios

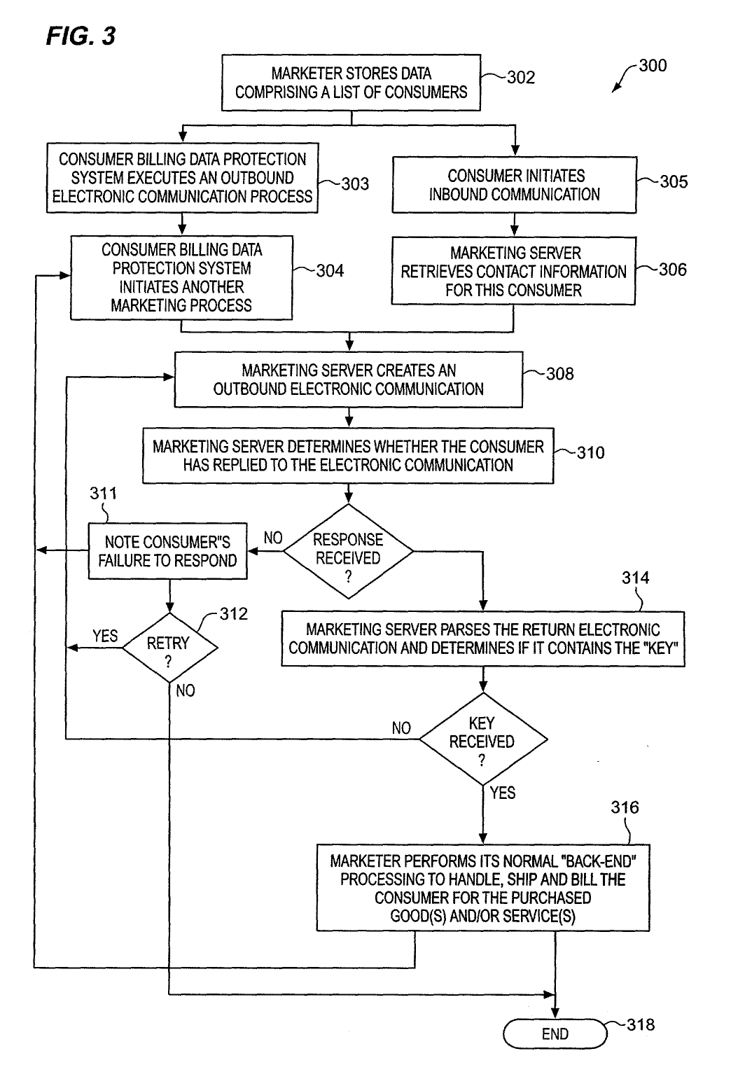

FIG. 3 is a flow chart depicting the operation of a lock-and-key consumer billing data protection system for electronic marketing for some alternative marketing situations. In an alternative sales scenario, the consumer can directly contact the marketer to initiate an inbound communication session, typically by contacting the marketer via the Marketer's WEB site. Alternatively, the marketer can be communicating with a consumer pursuant to an existing marketing process, and the marketer can initiate an electronic communication session with the consumer regarding another product or service while the initial communication session is still active.

Billing data protection process 300, which illustrates the order-entry functionality, consumer security and other advantages of consumer billing data protection system 100, begins at step 302, where a marketer has presently available or receives, either directly or indirectly via a seller engaging the marketer, data comprising a list of consumers (typically in the form of database records) such as from a list provider, which data is stored in the database 102 associated with marketing server 104.

There are several ways in which the consumer billing data protection system 100 can be in electronic communication with a particular consumer. The consumer billing data protection system 100 can execute an outbound electronic communication process at step 303, which outbound process is described above with respect to FIG. 2. Upon the conclusion of this outbound process or during this process, the consumer billing data protection system 100 can initiate another marketing process at step 304 by retrieving sales information, that identifies another product or service that is offered by the marketer, for transmission to the consumer who is presently in communication with the consumer billing data protection system 100. Alternatively, the consumer can initiate an inbound communication to the consumer billing data protection system 100 at step 305. In this instance, the marketing server 104 must identify this consumer from the list received in step 302. The consumer is identified by marketing server 104 via consumer identification information (e-mail address or caller identification or the like) received pursuant to the inbound communication, or via an exchange of messages with the consumer. Once the consumer is identified, the marketing server 104 retrieves the contact information for this consumer from database 102 at step 306.

In step 308, an automated system executing, for example, on marketing server 104 creates an outbound electronic communication that is appropriate for the communication medium presently in use to interconnect the consumer with the consumer billing data protection system 100. In the Internet communication case, the consumer billing data protection system 100 transmits a WEB page screen for display to a consumer using subscriber terminal equipment 111 which is connected to the Internet 108. In the case where the subscriber is using portable wireless terminal equipment 110, such as a mobile phone 112, personal data assistant and the like, the outbound electronic communication is a message (electronic mail, instant message, multi-media message, or the like) sent to a consumer via wireless mobile communications network 130. The electronic communication contains the sales message and requests that the consumer reply with the “key”—the missing billing information—if they desire to purchase the offered product(s) and/or service(s).

In step 310, consumer billing data protection system 100 (marketing server 104) determines, within a pre-determined time period, whether the consumer has replied to the electronic communication. If the determination of step 310 is negative, billing data protection process 300 notes the failure of consumer to reply in database 102 at step 311. At step 312 a determination is made by marketing server 104 whether to retry transmission of the electronic communication to the selected consumer. If not, processing terminates for this consumer at step 318. If a retry is elected, processing returns to step 308. Step 308 may be repeated for the particular consumer to again request the key or the consumer may be referred to a consumer service sales agent for specialized processing and follow-up. An additional option at step 311, is to initiate another marketing process at step 304, as described above.

Otherwise, if the determination of step 310 is positive this indicates that the consumer transmitted a return communication. The return communication from the selected consumer can be in any of a number of modes. The consumer can return an e-mail message to the marketing server 104, or can connect to the marketer's WEB site via the Internet 108, or the consumer can telephone the PSTN Interface 103 of the consumer billing data protection system 100 via a standard telephone (or cellular telephone) to provide the “key” to authorize the sale via tone signaling or an interaction with an agent, automated or not. The return electronic communication containing the key is the consumer's acceptance of the sales message's offer contained in the initial electronic communication. Billing data protection process 300 proceeds to step 314 where the consumer billing data protection system 100 (marketing server 104) parses the return electronic communication and determines if it contains the “key”—the missing billing information which the seller needs in order to access the consumer's account and bill them for the purchased good(s) and/or service(s). In an embodiment of lock-and-key consumer billing data protection, the key is m alphanumeric characters of the m+p alphanumeric character billing information where consumer billing data protection system 100 has previously stored the p alphanumeric characters in step 302 in marketing server 104. In an alternate embodiment, the key is the missing m alphanumeric characters of the m+p alphanumeric character credit card billing information in addition to other data unique to the consumer or the consumer's account (such as the ACS code commonly located on credit cards), and this additional information need not be part of the billing information needed to access consumers' account.

If the determination of step 314 is negative, billing data protection process 300 notes in database 102 the failure of consumer to provide the key in their reply and billing data protection process 300 returns to step 308 or exits for this consumer at step 318. Step 308 may be repeated for the particular consumer to again request the key or the consumer may be referred to a consumer service sales agent for specialized processing and follow-up.

Otherwise, if the determination of step 314 is positive, this indicates that the consumer proactively provided the key by sending a return electronic communication (electronic mail, instant message, wireless text/multi-media message or the like). The return electronic communication containing the key is the consumer's acceptance of the sales message's offer contained in the initial electronic communication. Billing data protection process 300 then proceeds to step 316 where the marketer and/or seller then performs its normal “back-end” processing to handle, ship—if applicable—and then bill the consumer for the purchased good(s) and/or service(s). Billing data protection process 300 then ends as indicated by step 318. An additional option at step 316 (or at step 314), is to initiate another marketing process at step 304, as described above.

Further Alternatives

While a number of embodiments of the present lock-and-key consumer billing data protection system for electronic marketing have been described above, it is also possible for the system to operate with the consumer's billing information being assembled at the entity that performs the consumer billing via the use of two separate data paths. In this instance, the marketer has partial billing information that comprises some information that can be used to identify the credit card used by the consumer in order for the marketer to communicate with the consumer. The key, obtained from the consumer by the marketer, is then forwarded to the billing entity by the marketer, typically along with the partial billing information that enables the billing entity to identify which of the customer's credit cards is being used. The list provider or seller forwards the remainder of the consumer's billing information to the billing entity, where the two partial sets of billing information are assembled to product the billing information that is used to bill the consumer for the purchased good(s) and/or service(s). In this manner, the p alphanumeric characters of the m+p alphanumeric character billing information can be transmitted directly to the entity that performs the customer billing, while the marketer only deals with the remaining m alphanumeric character billing information (the key).

Another alternative is where the marketer first receives the key from the consumer, then activates the marketing server to retrieve the partial billing information from the database for use by the billing entity. This process disseminates the partial billing information only when needed to complete a transaction.

Conclusion

While various embodiments of the present lock-and-key consumer billing data protection system for electronic marketing have been described above, it should be understood that they have been presented by way of example, and not limitation. It will be apparent to persons skilled in the relevant art(s) that various changes in form and detail can be made therein without departing from the spirit and scope of the invention. Thus, the present lock-and-key consumer billing data protection system for electronic commerce should not be limited by any of the above-described exemplary embodiments, but should be defined only in accordance with the following claims and their equivalents.

What is claimed:

1. A method for providing a consumer billing data protection capability in an electronic marketing system that stores a plurality of consumer records, each of which includes consumer identification information and partial billing information, comprising the steps of:
sending an electronic communication offer to a consumer corresponding to the consumer identification information stored in one of the plurality of consumer records;
receiving a return electronic communication containing a key from said consumer, said return electronic communication indicative that said consumer desires to purchase a product or service offered in said electronic communication offer, wherein said key completes said partial billing information stored in said one of said plurality of consumer records; and
processing an order for said product or service and billing for said order using the partial billing information stored in said one of the plurality of consumer records, and said key.

2. The method of claim 1, wherein said step of sending includes:
generating said electronic communication offer as an electronic mail message for transmission to said consumer via at least a portion of the Internet.

3. The method of claim 1, wherein said step of sending includes:
generating said electronic communication offer as an instant message for transmission to said consumer via at least a portion of the Internet.

4. The method of claim 1, wherein said step of sending includes:
generating said electronic communication offer as a text message for transmission to said consumer via at least a portion of a wireless mobile communications network.

5. The method of claim 1 wherein said key includes the ACS code of a credit card.

6. The method of claim 1, wherein each of the plurality of consumer records includes partial billing information comprising a predetermined set of p alphanumeric characters of the billing information of said consumer.

7. The method of claim 6, wherein said key is the remaining m alphanumeric characters of the billing information of said consumer, and wherein m+p is equal to the total number of alphanumeric characters in the billing information of said consumer.

8. The method of claim 1 further comprising:
retrieving said consumer identification information stored in one of the plurality of consumer records; and
generating said electronic communication offer that contains a message that offers a product or service for sale by said marketer.

9. The method of claim 1 further comprising:
receiving an electronic communication comprising an inquiry from a consumer;
retrieving said consumer identification information stored in one of the plurality of consumer records corresponding to the identity of said inquiry transmitting consumer; and
generating said offer electronic communication that contains a message that offers a product or service for sale by said marketer.

10. A method for providing a consumer billing data protection capability in an electronic marketing system, comprising the steps of:
storing a plurality of consumer records, each of which includes consumer identification information and partial billing information;
enabling a marketer, utilizing the electronic marketing system, to access said consumer identification information stored in one of said plurality of consumer records;
enabling said marketer, utilizing the electronic marketing system, to send an electronic communication offer to a consumer corresponding to said consumer identification information stored in said one of said plurality of consumer records;
receiving a return electronic communication containing a key from said consumer, said return electronic communication indicative that said consumer desires to purchase a product or service offered by said marketer in said electronic communication offer; and
processing an order reflective of said product or service and billing for said order using said key.

11. The method of claim 10, wherein said key is a predetermined set of p alpha-numeric characters of the billing information of said consumer, wherein said marketer has no access to a remaining m digits of the billing information of said consumer, and wherein m+p is equal to the total number of alpha-numeric characters in the billing information of said consumer.

12. The method of claim 10, wherein at least one of said outbound electronic communication and said return electronic communication is an electronic mail message transmitted via at least a portion of the Internet.

13. The method of claim 12, wherein at least one of said electronic communication offer and said return electronic communication is an instant message transmitted via at least a portion of the Internet.

14. The method of claim 12, wherein at least one of said electronic communication offer and said return electronic communication is a text message transmitted via at least a portion of a wireless mobile communications network.

15. The method of claim 10 further comprising:
retrieving said consumer identification information stored in one of the plurality of consumer records; and
generating said electronic communication offer that contains a message that offers a product or service for sale by said marketer.

16. The method of claim 10 further comprising:
receiving an electronic communication comprising an inquiry from a consumer;
retrieving said consumer identification information stored in one of the plurality of consumer records corresponding to the identity of said inquiry transmitting consumer; and
generating said electronic communication offer that contains a message that offers a product or service for sale by said marketer.

17. A method for providing a consumer billing data protection capability in an electronic marketing system that stores a plurality of consumer records, each of which includes consumer identification information and partial billing information, comprising the steps of:
receiving a key, indicative that a consumer corresponding to the consumer identification information stored in one of the plurality of consumer records, desires to purchase an offered product or service, and wherein said key completes the partial billing information stored in said one of the plurality of consumer records; and
processing an order for said product or service and billing for said order using the partial billing information stored in said one of the plurality of consumer records, and said key.

18. The method of claim 17, further comprising the step of:
enabling a marketer utilizing the electronic marketing system to access the consumer identification information stored in said one of the plurality of consumer records.

19. The method of claim 17, wherein said key includes the ACS code of a credit card.

20. The method of claim 17, wherein the partial billing information stored in each of the plurality of consumer records is a predetermined set of p alphanumeric characters of the billing information of said consumer.

21. The method of claim 20, wherein said key is the remaining m alphanumeric characters of the billing information of said consumer, and wherein m+p is equal to the total number of alphanumeric characters in the billing information of said consumer.

22. The method of claim 17 further comprising:
retrieving said consumer identification information stored in one of the plurality of consumer records;
generating said electronic communication offer that contains a message that offers a product or service for sale by said marketer; and
sending an electronic communication offer to a consumer corresponding to the consumer identification information stored in one of the plurality of consumer records.

23. The method of claim 17 further comprising:
receiving an electronic communication comprising an inquiry from a consumer;
retrieving said consumer identification information stored in one of the plurality of consumer records corresponding to the identity of said inquiry transmitting consumer;
generating said electronic communication offer that contains a message that offers a product or service for sale by said marketer; and
sending an electronic communication offer to a consumer corresponding to the consumer identification information stored in one of the plurality of consumer records.

24. A method for providing a consumer billing data protection capability in an electronic marketing system, comprising the steps of:
storing a plurality of consumer records, each of which includes consumer identification information and partial billing information;
enabling a marketer, utilizing the electronic marketing system, to access said consumer identification information stored in one of said plurality of consumer records;
receiving a key from a consumer, indicative that said consumer, who corresponds to said consumer identification information stored in said one of said plurality of consumer records, desires to purchase a product or service offered by said marketer; and
processing an order reflective of said product or service and billing for said order using said key.

25. The method of claim 24, wherein said key is a predetermined set of p alpha-numeric characters of the billing information of said consumer, wherein said marketer has no access to a remaining m digits of the billing information of said consumer, and wherein m+p is equal to the total number of alpha-numeric characters in the billing information of said consumer.

26. A system for providing a consumer billing data protection capability in an electronic marketing system that stores a plurality of consumer records, each of which includes consumer identification information, comprising:
means for sending an electronic communication offer to a consumer corresponding to the consumer identification information stored in one of the plurality of consumer records;
means for receiving a return electronic communication containing a key from said consumer, said return electronic communication indicative that said consumer desires to purchase a product or service offered in said electronic communication offer; and
means for processing an order for said product or service and billing for said order using the consumer identification information stored in said one of the plurality of consumer records, and said key.

27. The system of claim 26, wherein said means for sending includes:
means for generating said electronic communication offer as an electronic mail message for transmission via at least a portion of the Internet.

28. The system of claim 26, wherein said means for sending includes:
means for generating said electronic communication offer as an instant message for transmission via at least a portion of the Internet.

29. The system of claim 26, wherein said means for sending includes:
means for generating said electronic communication offer as a text message for transmission via at least a portion of a wireless mobile communications network.

30. The system of claim 26, further comprising:
means for enabling a marketer utilizing the electronic marketing system to access the consumer identification information stored in said one of the plurality of consumer records.

31. The system of claim 26 wherein said key includes the ACS code of a credit card.

32. The system of claim 26, wherein each of the plurality of consumer records includes partial billing information comprising a predetermined set of p alphanumeric characters of the billing information of said consumer.

33. The system of claim 32, wherein said key is the remaining m alphanumeric characters of the billing information of said consumer, and wherein m+p is equal to the total number of alphanumeric characters in the billing information of said consumer.

34. The system of claim 26 further comprising:
means for retrieving said consumer identification information stored in one of the plurality of consumer records; and
means for generating said electronic communication offer that contains a message that offers a product or service for sale by said marketer.

35. The system of claim 26 further comprising:
means for receiving an electronic communication comprising an inquiry from a consumer;
means for retrieving said consumer identification information stored in one of the plurality of consumer records corresponding to the identity of said inquiry transmitting consumer; and
means for generating said electronic communication offer that contains a message that offers a product or service for sale by said marketer.

36. A system for providing a consumer billing data protection capability in an electronic marketing system, comprising:
storage means for storing a plurality of consumer records, each of which includes consumer identification information;
means for enabling a marketer, utilizing the electronic marketing system, to access said consumer identification information stored in one of said plurality of consumer records;
means for enabling said marketer, utilizing the electronic marketing system, to send an electronic communication offer to a consumer corresponding to said consumer identification information stored in said one of said plurality of consumer records;
means for receiving a return electronic communication containing a key from said consumer, said return electronic communication indicative that said consumer desires to purchase a product or service offered by said marketer in said electronic communication offer; and
means for processing an order reflective of said product or service and billing for said order using said key.

37. The system of claim 36, wherein said key is a predetermined set of p alpha-numeric characters of the billing information of said consumer, wherein said marketer has no access to a remaining m digits of the billing information of said consumer, and wherein m+p is equal to the total number of alpha-numeric characters in the billing information of said consumer.

38. The system of claim 37, wherein at least one of said electronic communication offer and said return electronic communication is an electronic mail message transmitted via at least a portion of the Internet.

39. The system of claim 36, wherein at least one of said electronic communication offer and said return electronic communication is an instant message transmitted via at least a portion of the Internet.

40. The system of claim 36, wherein at least one of said electronic communication offer and said return electronic communication is a text message transmitted via at least a portion of a wireless mobile communications network.

41. The system of claim 36 further comprising:
means for retrieving said consumer identification information stored in one of the plurality of consumer records; and
means for generating said electronic communication offer that contains a message that offers a product or service for sale by said marketer.

42. The method of claim 36 further comprising:
means for receiving an electronic communication comprising an inquiry from a consumer;
means for retrieving said consumer identification information stored in one of the plurality of consumer records corresponding to the identity of said inquiry transmitting consumer; and
means for generating said electronic communication offer that contains a message that offers a product or service for sale by said marketer.
